(19) United States
(12) Patent Application Publication
(10) Pub. No.: US 2003/0133722 A1
(43) Pub. Date: Jul. 17, 2003

(54) Image forming apparatus capable of detecting a remaining amount of toner with high accuracy

(75) Inventor: Satoshi Kaiho, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/043,141

(22) Filed: Jan. 14, 2002

(51) Int. Cl. G03G 15/08

(52) U.S. Cl. 399/27; 399/260

(57) ABSTRACT

An image forming apparatus is formed of a toner bottle for storing toner, a driving portion for rotating the toner bottle, a rib and a sensor for detecting a rotation number of the toner bottle, a conveying auger rotated synchronously with the toner bottle to control and supply a constant amount at a time of toner in the toner bottle, a CPU as a supplied toner amount detecting device for calculating a supplied toner amount by multiplying the rotation number of the conveying auger which is the same as that of the toner bottle by a conveyed toner amount for a turn of the conveying auger, a CPU as remaining toner amount calculating device for calculating a remaining toner amount by subtracting the supplied toner amount from a total amount in the toner bottle, and a display for displaying a toner-near-empty state when the remaining toner amount is equal to or smaller than a set amount.

### BACKGROUND OF THE INVENTION

1. Field of the Invention

The present invention relates to an image forming apparatus for keeping track of a remaining toner amount and preventing interruption of printing due to insufficient toner.

2. Description of the Related Art

In general, in an image forming apparatus such as a copying machine and a facsimile, a constant amount of toner is mounted. When an amount of toner reduces by using the copying machine or the like, a remaining toner amount is checked and toner is newly supplied if necessary.

The remaining toner amount is conventionally sensed by a toner density sensor disposed in a developing device or a sensor provided in a toner cartridge.

Toner is supplied from the image forming apparatus to the developing device by the toner cartridge. In this case, for a purpose of reducing the number of parts so as to reduce a cost of the cartridge, the toner cartridge is of a bottle type and the bottle is directly rotated to supply toner.

In the above image forming apparatus, because toner in the toner cartridge of the bottle type is stirred and it is impossible to provide a sensor to a toner cartridge main body which is a consumable item, it is difficult to directly measure the remaining toner amount by low-cost means.

Therefore, toner insufficiency may be suddenly indicated to interrupt printing when the remaining toner amount is small. In such a case, there is no problem if a user is near an apparatus main body. However, if the user leaves the apparatus main body after commanding large-volume printing, operation remains interrupted and a printing operation is delayed.

### SUMMARY OF THE INVENTION

The present invention has been accomplished with the above problems in view and an object of the invention is as follows. It is an object of the invention to provide an image forming apparatus in which a remaining toner amount can be measured indirectly.

An image forming apparatus according to a first aspect of the present invention comprises toner flow rate control means for controlling and supplying a constant amount at a time of toner stored in a toner reservoir when the toner is used, wherein the apparatus further comprises supplied toner amount detecting means for detecting an amount of the toner supplied by the toner flow rate control means when the toner flow rate control means is actuated to supply the toner and remaining toner amount calculating means for calculating a remaining toner amount in the toner reservoir by subtracting the supplied toner amount detected by the supplied toner amount detecting means from a total amount in the toner reservoir.

With the above structure, the amount of toner supplied by the toner flow rate control means is detected by the supplied toner amount detecting means. Then, in the remaining toner amount calculating means, the remaining toner amount in the toner reservoir is calculated by subtracting the supplied toner amount detected by the supplied toner amount detecting means from a total amount in the toner reservoir. Every time the toner is supplied by the toner flow rate control means, the remaining toner amount is calculated. When the remaining toner amount reduces to the set value, the toner is supplied to the toner reservoir.

In the image forming apparatus according to the first aspect, it is preferable that the toner flow rate control means is formed of an auger and that the supplied toner amount detecting means is formed of auger rotation number detecting means for detecting a rotation number of the auger and computing means for calculating the supplied toner amount by multiplying the rotation number of the auger detected by the auger rotation number detecting means by a conveyed toner amount for a turn of the auger.

With the above structure, the rotation number of the auger is controlled to control the toner flow rate. The auger rotation number is detected by the auger rotation number detecting means of the supplied toner amount detecting means and the supplied toner amount is calculated by multiplying the detected rotation number by the conveyed toner amount for a turn of the auger by the computing means.

In the image forming apparatus according to the first aspect, it is preferable that the apparatus further comprises display means for displaying the remaining toner amount calculated by the remaining toner amount calculating means.

With the above structure, by displaying the remaining toner amount by the display means, the operation does not stop due to sudden running out of the toner.

In the image forming apparatus according to the first aspect, it is preferable that the apparatus further comprises display means for displaying that the remaining toner amount is small when the remaining toner amount calculated by the remaining toner amount calculating means is equal to or smaller than a set amount.

With the above structure, when the display means displays that the remaining toner amount is small, the toner is supplied. As a result, the operation does not stop due to sudden running out of the toner.

An image forming apparatus according to a second aspect of the present invention comprises a toner bottle for storing toner, toner flow rate control means for controlling and supplying a constant amount at a time of toner in the toner bottle when the toner is used, supplied toner amount detecting means for detecting an amount of the toner supplied by the toner flow rate control means when the toner flow rate control means is actuated to supply the toner, and remaining toner amount calculating means for calculating a remaining toner amount in the toner bottle by subtracting the supplied toner amount detected by the supplied toner amount detecting means from a total amount in the toner bottle.

With the above structure, similarly to the first aspect, the amount of toner supplied by the toner flow rate control means is detected by the supplied toner amount detecting means. Then, in the remaining toner amount calculating means, the remaining toner amount in the toner bottle is calculated by subtracting the supplied toner amount detected by the supplied toner amount detecting means from a total amount in the toner bottle. Every time the toner is supplied by the toner flow rate control means, the remaining toner amount is calculated. When the remaining-toner amount reduces to the set value, the toner is supplied to the toner bottle.

In the image forming apparatus according to the second aspect, it is preferable that the toner flow rate control means is formed of an auger and that the supplied toner amount detecting means is formed of auger rotation number detecting means for detecting a rotation number of the auger and computing means for calculating the supplied toner amount by multiplying the rotation number of the auger detected by the auger rotation number detecting means by a conveyed toner amount for a turn of the auger.

With the above structure, similarly to the first aspect, the rotation number of the auger is controlled to control the toner flow rate. The auger rotation number is detected by the auger rotation number detecting means of the supplied toner amount detecting means and the supplied toner amount is calculated by multiplying the detected rotation number by the conveyed toner amount for a turn of the auger by the computing means.

In the image forming apparatus according to the second aspect, it is preferable that the apparatus further comprises display means for displaying the remaining toner amount calculated by the remaining toner amount calculating means.

With the above structure, similarly to the first aspect, by displaying the remaining toner amount by the display means, the operation does not stop due to sudden running out of the toner.

In the image forming apparatus according to the second aspect, it is preferable that the apparatus further comprises display means for indicating that the remaining toner amount is small when the remaining toner amount calculated by the remaining toner amount calculating means is equal to or smaller than a set amount.

With the above structure, similarly to the first aspect, when the display means indicates that the remaining toner amount is small, the toner is supplied. As a result, the operation does not stop due to sudden running out of the toner.

An image forming apparatus according to a third aspect of the present invention comprises a toner bottle for storing toner, toner bottle rotating means for rotating the toner bottle, toner bottle rotation number detecting means for detecting a rotation number of the toner bottle rotated by the toner bottle rotating means, an auger rotated synchronously with the toner bottle to control and supply a constant amount at a time of toner in the toner bottle when the toner is used, computing means for calculating a supplied toner amount by multiplying the rotation number of the auger determined according to the rotation number of the toner bottle detected by the toner bottle rotation number detecting means by a conveyed toner amount for a turn of the auger, remaining toner amount calculating means for calculating a remaining toner amount in the toner bottle by subtracting the supplied toner amount calculated by the computing means from a total amount in the toner bottle, and display means for indicating the remaining toner amount calculated by the remaining toner amount calculating means or for displaying that the remaining toner amount is small when the remaining toner amount is equal to or smaller than a set amount.

With the above structure, the toner bottle in which the toner is stored is rotated by the toner bottle rotating means and the toner in the toner bottle is moved toward the auger. By the toner bottle rotation number detecting means, the rotation number of the toner bottle is detected and the rotation number of the auger rotating synchronously with the toner bottle is determined. In the computing means, the supplied toner amount is calculated by multiplying the rotation number of the auger by the conveyed toner amount for a turn of the auger. In the remaining toner amount calculating means, the remaining toner amount in the toner bottle is calculated by subtracting the supplied toner amount from the total amount in the toner bottle. The calculated remaining toner amount is displayed by the display means. At this time, the remaining toner amount is displayed as it is or a fact that the remaining toner amount is small is displayed when the remaining toner amount is equal to or smaller than the set amount (shortly before the toner completely runs out).

In the image forming apparatus according to the third aspect, it is preferable that the same driving means is used for the toner bottle rotation and the auger operation.

With the above structure, rotation of the toner bottle and rotation of the auger are synchronized with each other. As a result, by detecting the rotation number of the toner bottle by the toner bottle rotation number detecting means, the rotation number of the auger rotating synchronously with the toner bottle can be determined.

In the image forming apparatus according to the third aspect, it is preferable that the toner bottle is provided with a toner buffer and the auger is mounted in the toner buffer.

With the above structure, the toner in the toner bottle is gathered into the toner buffer and the auger in the toner buffer supplies a constant amount of toner at a time. As a result, variations in the amount of toner entering the auger can be prevented and the toner in the toner bottle can be efficiently raked and supplied outside.

### BRIEF DESCRIPTION OF THE DRAWINGS

FIG. 1 is a schematic sectional view of a structure of an image forming apparatus according to an embodiment of the present invention.

FIG. 2 is a perspective view of a toner bottle and a driving portion of the image forming apparatus according to the embodiment of the invention.

FIG. 3 is a sectional view of the driving portion of the image forming apparatus according to the embodiment of the invention.

FIG. 4 is a perspective view of the driving portion of the image forming apparatus according to the embodiment of the invention.

FIG. 5 is a functional block diagram of a control circuit for controlling the image forming apparatus according to the embodiment of the invention.

FIG. 6 is a flow chart showing a procedure of processing of a remaining toner amount check routine.

FIG. 7 is a diagrammatic sketch showing an example of display when a remaining toner amount is indicated by a display.

### DESCRIPTION OF THE PREFERRED EMBODIMENTS

The best embodiment of an image forming apparatus according to the present invention will be described below by reference to the accompanying drawings.

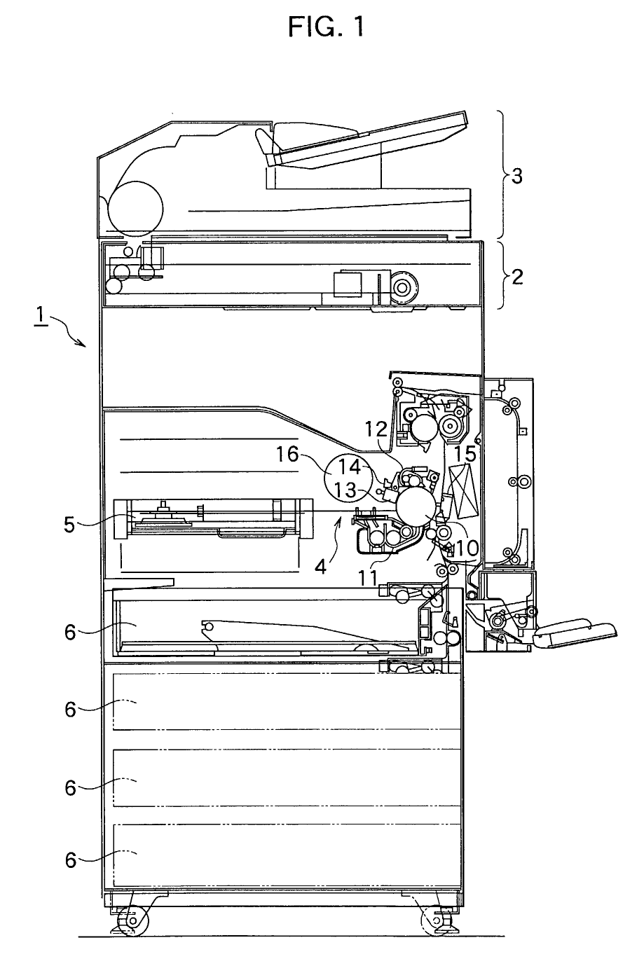

FIG. 1 is a schematic sectional view of a structure of the image forming apparatus according to the present embodiment.

The image forming apparatus 1 of the embodiment mainly includes an image reading portion 2, an automatic document feeder 3, an image saving portion (not shown), an image forming portion 4, and a laser optical device 5. A plurality of printing paper trays 6 in which sheets of printing paper in different sizes are placed respectively below the laser optical device 5.

The image reading portion 2 is a device for reading an image on a surface of a document by shining light on the surface of the document and for converting the image into electric signals. The automatic document feeder 3 is a device for automatically feeding a set document to the image reading portion 2. The image saving portion is a device for capturing and storing image data read by the image reading portion 2 and outputting it if necessary.

The image forming portion 4 is a device for forming an image based on the image data saved in the image saving portion. The image forming portion 4 mainly includes a photosensitive drum 10, in which charge on a surface is partially removed by laser beam according to the image data on the document, a developing device 11 for developing by adhering toner to the surface of the photosensitive drum 10 charged according to the image data, a cleaner 12 for removing toner left on the surface of the photosensitive drum 10, an electrostatic charger 13 for electrostatically charging the surface of the photosensitive drum 10, a charge-removing lamp 14 for removing charge on the surface of the photosensitive drum 10, and a transferring/peeling charger 15.

The laser optical device 5 is a device for irradiating the laser beam to the surface of the photosensitive drum 10 of the image forming portion 4 based on the image data. The laser optical device 5 retrieves the image data saved in the image saving portion and irradiates the laser beam to the surface of the photosensitive drum 10 of the image forming portion 4 to form a visible image.

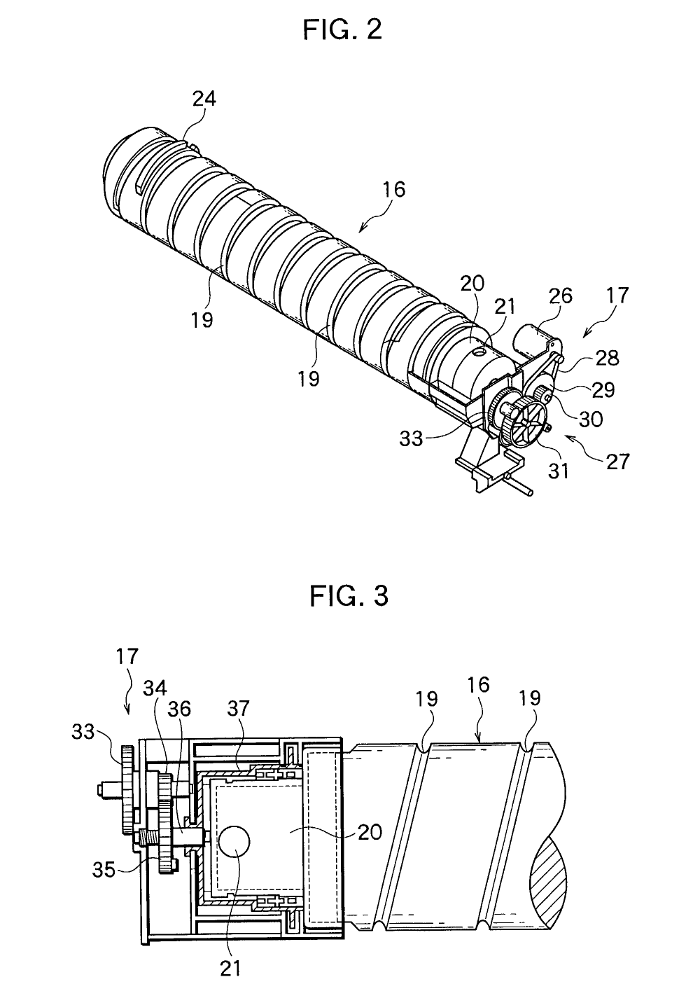

The developing device 11 includes a toner bottle 16 and a driving portion 17 (see FIG. 2) for rotating the toner bottle 16. The toner bottle 16 and the driving portion 17 are formed as shown in FIG. 2. The driving portion 17 is mounted to one end portion (right end portion in FIG. 2) which is an opening portion of the toner bottle 16. The toner bottle 16 is in a shape of a cone with a diameter slightly reducing toward the one end portion. A helical groove 19 (convex projecting inward) is provided throughout a conical wall face of the toner bottle 16. The helical groove 19 is a member for raking toner inside the toner bottle 16 toward the driving portion 17 by rotating the toner bottle 16. By both the helical groove 19 and a tapered shape of the toner bottle 16 toward the driving portion 17, it is easy to gather the toner into the driving portion 17. In other words, by rotating the toner bottle 16, the helical groove 19 is rotated and the toner scattered in the toner bottle 16 throughout is raked toward the driving portion 17, gathered in the conical toner bottle 16 which is gradually becoming narrower, and sent toward the driving portion 17. A cap 20 having a discharge port 21 is provided to the opening portion side of the toner bottle 16. The discharge port 21 of the cap 20 discharges and supplies the toner to a toner buffer 41 which will be described later when the toner bottle 16 rotates a turn and the discharge port 21 passes through a lower side of the toner bottle 16.

A rib 24 is provided to an outer peripheral surface of the other end portion (left end portion in FIG. 2) of the toner bottle 16. The rib 24 is a member for detecting the number of rotations of the toner bottle 16. The rib 24 is provided to correspond to the discharge port 21 of the cap 20. A sensor 102, which will be described later, is provided to face the rib 24 and the rib 24 is detected once every time the toner bottle 16 rotates.

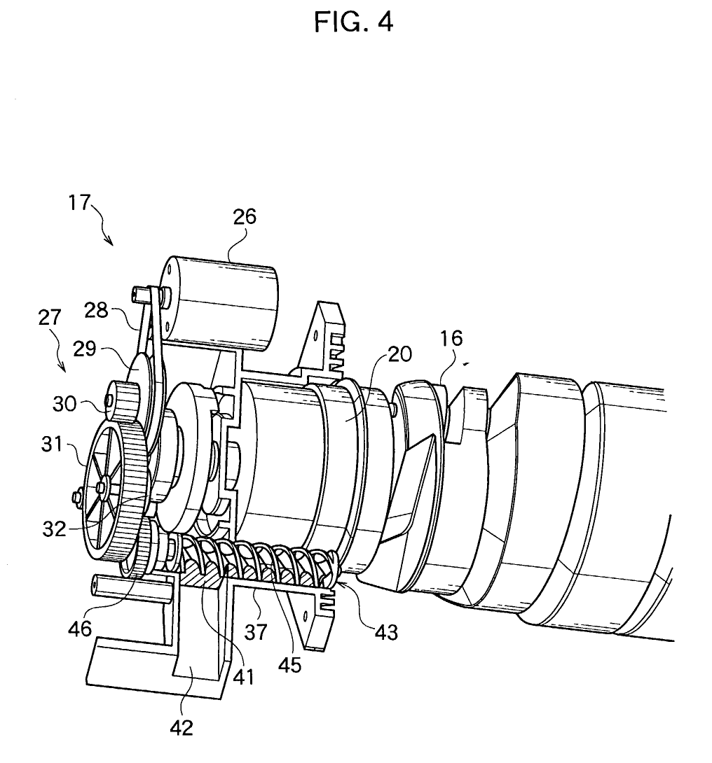

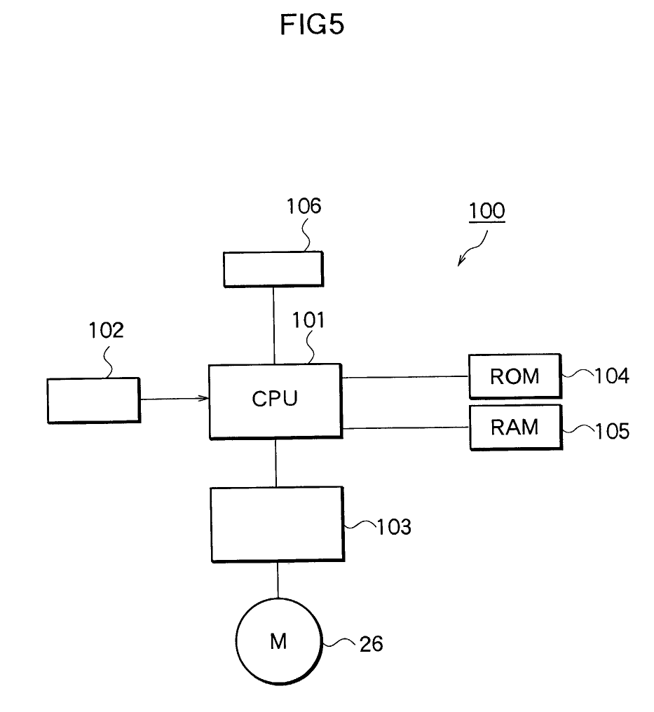

The driving portion 17 is formed as shown in FIGS. 2 to 4. The driving portion 17 is mainly formed of a driving motor 26 and a speed change portion 27. The driving motor 26 is a motor for driving the toner bottle 16 and a conveying auger 43 for rotation, which will be described later. The driving motor 26 is connected to a speed change portion 27 by a belt 28 for transferring rotation.

The speed change portion 27 is formed of a pulley 29 connected by the belt 28 to the driving motor 26, a first driving gear 30 integrally provided to the pulley 29, a second driving gear 31 which is engaged with the first driving gear 30 and to which rotation is transferred, a third driving gear 32 integrally provided to the second driving gear 31, a fourth driving gear 33 which is engaged with the third driving gear 32 and to which rotation is transferred, a fifth driving gear 34 integrally provided to the fourth driving gear 33, and a sixth driving gear 35 which is engaged with the fifth driving gear 34 and to which rotation is transferred. Thus, rotation of the driving motor 26 is transferred to the toner bottle 16 and the like while a speed of the rotation is substantially reduced. A drive shaft 36 for rotating the toner bottle 16 is connected to the sixth driving gear 35. Meanwhile, the sixth driving gear 35 is mounted for sliding in an axial direction of the drive shaft 36. The drive shaft 36 is connected to a holder guide 37. The holder guide 37 is a member to be fitted with the cap 20 of the toner bottle 16. The holder guide 37 is formed in a tubular shape with a bottom. Thus, the holder guide 37 is fitted with the cap 20 in such a manner that the cap 20 is covered with the holder guide 37. By fitting of the cap 20 with the holder guide 37, the toner bottle 16 is mounted to the driving portion 17.

The toner buffer 41 is formed at a lower portion of the holder guide 37. The toner buffer 41 is a chamber for temporarily store the toner from the toner bottle 16. The toner from the toner bottle 16 is dropped and supplied into the toner buffer 41 from the discharge port 21 of the cap 20 by rotation of the toner bottle 16. Thus, the toner buffer 41 is constantly filled with the toner by rotation of the toner bottle 16. The toner buffer 41 is formed as a cylindrical space parallel to the toner bottle 16. The conveying auger 43 which will be described later is mounted for rotation in the cylindrical space of the toner buffer 41. A discharge port 42 is provided to an end portion of the toner buffer 41 and the toner is supplied to the developing device 11.

The conveying auger 43 is mounted in the toner buffer 41. The conveying auger 43 is formed of a conveying plate 45 formed in a helical shape around a shaft core and a driving gear 46 integrally mounted to an end portion of the conveying plate 45. The conveying auger 43 is mounted for rotation in the toner buffer 41. The helical conveying plate 45 is formed with a constant pitch. By every turn of the conveying auger 43, a constant amount of toner is conveyed. In other words, the conveying auger 43 forms toner flow rate control means for controlling and supplying the constant amount of toner at a time when the toner is used (supplied to the developing device 11). The conveying plate 45 has such dimensions as to be fitted in the cylindrical space of the toner buffer 41 substantially without a gap.

The conveying auger 43 is disposed parallel to the toner bottle 16 in a state in which the conveying auger 43 is fitted in the toner buffer 41. The driving gear 46 is engaged with the fifth driving gear 34 of the speed change portion 27. With this fifth driving gear 34, the sixth driving gear 35 of the drive shaft 36 for rotating the toner bottle 16 is also engaged. Thus, the conveying auger 43 and the toner bottle 16 rotate synchronously. Furthermore, the number of cogs of the driving gear 46 of the conveying auger 43 is set at the same number as that of the sixth driving gear 35 of the toner bottle 16. When the toner bottle 16 rotates a turn, the conveying auger 43 also rotates a turn synchronously. A speed ratio between the toner bottle 16 and the conveying auger 43 is set properly according to differences between dimensions of respective portions and the like.

In the present embodiment, a control circuit 100 shown in FIG. 5 is provided for controlling rotation of the toner bottle 16 and carrying out processing such as determination. The control circuit 100 includes a CPU 101 for controlling entire operation of the image forming apparatus 1, the sensor 102 for detecting the rib 24 of the toner bottle 16 and outputting a detection signal to the CPU 101, a motor driver 103 for driving and controlling a motor 27 of the driving portion 17 when a control signal is given to the motor driver 103 by the CPU 101, a ROM 104 for storing a program for designating an operation procedure to the CPU 101, a RAM 105 for storing and reading data if necessary, and a display 106 for displaying a calculated remaining toner amount as it is or for indicating that a remaining toner amount is small when the remaining toner amount becomes equal to or smaller than a set amount.

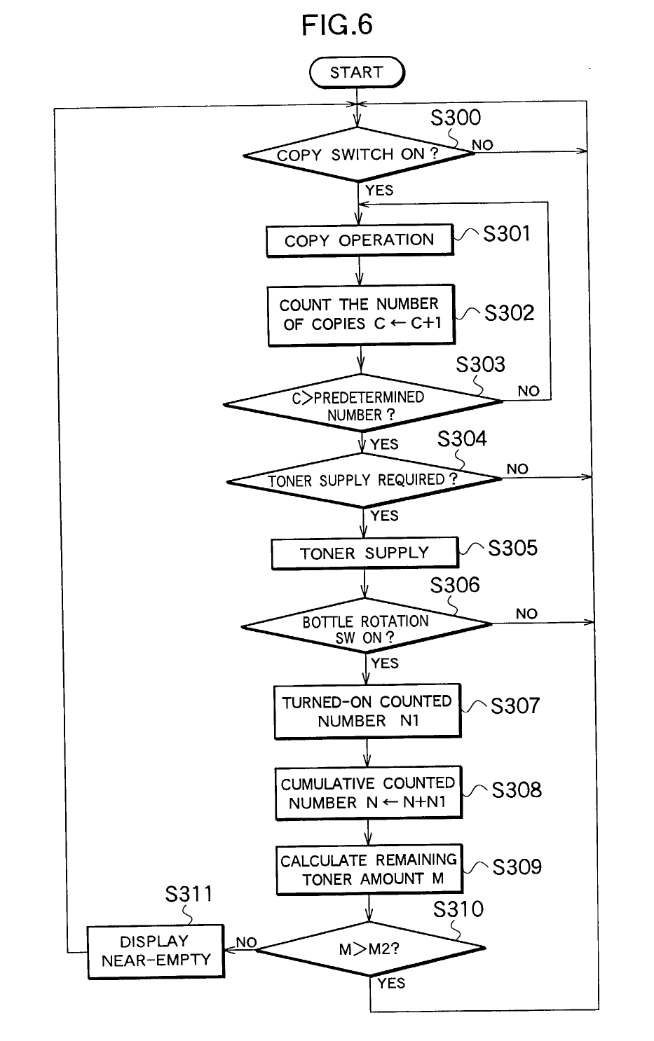

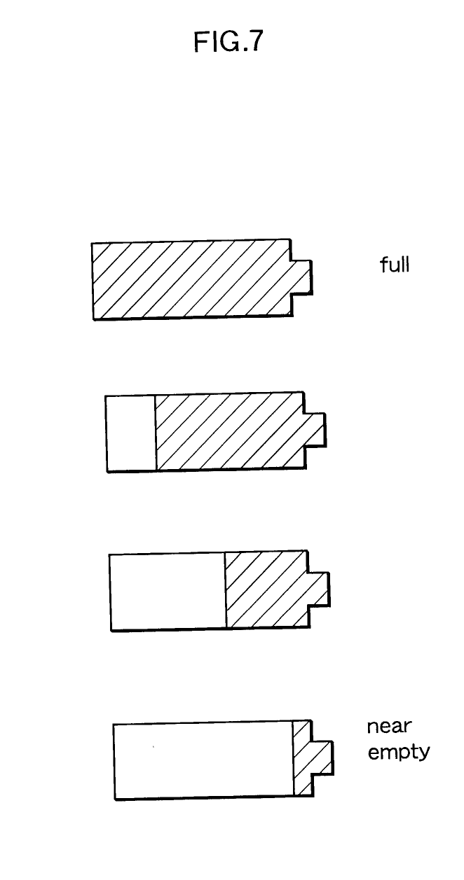

The CPU 101 outputs the control signal to the motor driver 103 and drives the driving motor 26 through the motor driver 103 according to means which will be described later by using a flow chart shown in FIG. 6. Then, the toner bottle 16 is rotated by the driving motor 26 and the sensor 102 which has detected the rib 24 of the toner bottle 16 sends the detection signal to the CPU 101. The CPU 101 counts the number of rotation of the toner bottle 16 based on the detection signal and calculates the remaining amount of the toner based on a count value. To put is concretely, the calculation is carried out as follows.

An amount of toner to be supplied to the developing device 11 is determined by the number of rotation of the conveying auger 43 for supplying the toner to the developing device 11. Here, the toner bottle 16 and the conveying auger 43 are controlled by a single motor and rotate simultaneously. Because the toner discharged from the toner bottle 16 is temporarily stored in the toner buffer 41, an amount of toner dropped into the developing device 11 is not influenced by an amount of toner discharged from the toner bottle 16. Therefore, by counting the number of rotation of the conveying auger 43 through the number of rotation of the toner bottle 16, it is possible to detect a supplied amount of toner with accuracy.

The toner flow rate for every turn of the conveying auger 43 is defined as m, toner weight when the toner bottle 16 is full of toner is defined as M1, and a predetermined amount (toner empty) when the remaining toner amount is close to zero is defined as M2.

The number of rotation of the conveying auger 43 (toner bottle 16) is defined as N.

At this time, the remaining toner amount M is expressed by

M=M1−m·N (1)

Therefore, when

M=M1−m·N<M2 (2),

the display 106 displays a toner-near-empty state.

The CPU 101 for performing a computation of the above m·N forms supplied toner amount detecting means for detecting the amount of toner supplied by the conveying auger 43 in supplying the toner. The CPU 101 for performing a computation of the above expression (1) forms remaining toner amount calculating means for calculating the remaining toner amount in the toner bottle 16.

The sensor 102 is provided to face the rib 24 of the toner bottle 16. The sensor 102 and the rib 24 form toner bottle rotation number detecting means. The sensor 102 detects the rib 24 and sends the detection signal to the CPU 101 for every detection. Detecting the rib 24 once by the sensor 102 corresponds to a turn of the toner bottle 16. The sensor 102 may detect the rib 24 and various kinds of sensors can be used as the sensor 102. It is also possible to detect rotation of the toner bottle 16 by using other portions such as a gear portion without using the rib 24. As the sensor, it is possible to use, for example, an optical sensor, a magnetometric sensor, a mechanical switch, and the like.

The display 106 is display means for indicating that the remaining toner amount is small when the calculated remaining toner amount becomes equal to or smaller than the set amount. To put it concretely, the display 106 displays the toner-near-empty state. For the display 106, one device may be provided to the image forming apparatus 1 or a display which is normally provided for operation may be used. If the display which is normally provided is used, the toner-near-empty state may be indicated by a special screen formed in a screen of a liquid crystal display, a CRT, or the like or may be indicated together with normal information.

Next, the operation of the image forming apparatus 1 with the above structure will be described based on the flow chart in FIG. 6. FIG. 6 is the flow chart showing the procedure of processing of a remaining toner amount check routine.

In step S300, it is determined whether a copy switch has been turned on or not. If the switch has not been turned on, the flow returns until the switch is turned on. If the remaining toner amount check routine is a subroutine, the flow returns to a main routine. If a user sets the number of copies and turns the switch on, copying operation is carried out in step S301. Then, in step S302, the number C of copies is counted every time a copy is made. Then, in step S303, it is determined whether the number C of copies has exceeded a set number or not. If the number C of copies has not exceeded the set number, the flow returns to the step S301 and repeats the above processing. If the number C of copies has exceeded the set number, the flowchart proceeds to the next step S304. In step S304, it is determined whether the developing device 11 has required a supply of toner or not. If the developing device 11 has not required the supply, the flow returns to step S300 and it is determined whether the copy switch has been turned on again or not.

If the developing device 11 has required the supply of toner, toner supplying operation is carried out in step S305. In this case, the toner supplying operation may be carried out without driving of the driving motor 26 in some cases. Operation when the driving motor 26 is driven is as follows. By operation of the driving motor 26, the pulley 29 rotates and the gears 30, 31, 32, and 33 rotate respectively. As a result, the toner bottle 16 rotates and toner is supplied from the discharge port 21 of the cap 20 to the toner buffer 41. Furthermore, the conveying auger 43 is rotated. By rotation of the conveying auger 43, the conveying plate 45 rotates and a constant amount of toner is supplied from the discharge port 42 to the developing device 11.

Then, in step S306, if a rotation SW (not shown) of the toner bottle 16 has been turned on, i.e., it is determined whether the driving motor 26 has been rotated by the motor driver 103 or not. If the rotation SW has not been turned on, the flow returns to step S300. If the rotation SW has been turned on, the number N1 of detection of the rib 24 by the sensor 102 is counted in step S307.

Next, in step S308, the counted number N1 in S307 is added to a cumulative count N.

In step S309, the remaining toner amount M is calculated from the cumulative count N according to the expression (1). Then, in step S310, if M>M2 is determined. If M>M2, the flow returns to step S300. In other cases, the flow proceeds to step S311, the near-empty-state is displayed by the display 106, and the flow returns to step S300.

According to the above embodiment, because the computation of the remaining toner amount is performed every time toner is supplied to the developing device 11, it is possible to detect the remaining toner amount in real time.

When the remaining toner amount is nearly empty, it is possible to indicate the near-empty-state. As a result, the user can know that the remaining amount in the toner bottle 16 is small. Thus, before the toner runs out and the image forming apparatus 1 becomes inoperable, it is possible to find that the remaining amount of toner is small and to take precautionary measures such as keeping of a new toner cartridge in advance.

Because the toner bottle 16 and the conveying auger 43 are interlocked with each other, it is possible to detect the remaining toner amount with high accuracy irrespective of a variation in the speed of rotation of the toner bottle 16.

The above-described embodiment is an example and does not limit the invention. Various modifications can be made without departing from the scope of right of the invention. For example, an outside shape of the toner bottle 16 and a structure of the driving portion are not limited to those shown in FIGS. 1 to 4. A shape of the rib provided to the outer periphery of the toner bottle 16 is not limited to that shown in FIG. 2 and can be changed if necessary.

Although the remaining toner amount is detected by counting the number of rotation of the toner bottle 16 in the above embodiment, it is possible to provide auger rotation number detecting means for directly detecting the number of rotation of the conveying auger 43.

Although the conveying auger 43 is used as toner flow rate control means in the above embodiment, it is needless to say that conveying means other than the conveying auger 43 can be employed.

Although the toner-near-empty state is displayed by the display 106 in the above embodiment, it is also possible to display the remaining toner amount.

What is claimed is:

1. An image forming apparatus comprising toner flow rate control means for controlling and supplying a constant amount at a time of toner stored in a toner reservoir when said toner is used,
wherein said apparatus further comprises:
supplied toner amount detecting means for detecting an amount of said toner supplied by said toner flow rate control means when said toner flow rate control means is actuated to supply said toner and
remaining toner amount calculating means for calculating a remaining toner amount in said toner reservoir by subtracting said supplied toner amount detected by said supplied toner amount detecting means from a total amount in said toner reservoir.

2. An image forming apparatus according to claim 1,
wherein said toner flow rate control means is formed of an auger and
said supplied toner amount detecting means is formed of auger rotation number detecting means for detecting a rotation number of said auger and computing means for calculating said supplied toner amount by multiplying said rotation number of said auger detected by said auger rotation number detecting means by a conveyed toner amount for a turn of said auger.

3. An image forming apparatus according to claim 1, further comprising display means for displaying said remaining toner amount calculated by said remaining toner amount calculating means.

4. An image forming apparatus according to claim 1, further comprising display means for displaying that said remaining toner amount is small when said remaining toner amount calculated by said remaining toner amount calculating means is equal to or smaller than a set amount.

5. An image forming apparatus comprising:
a toner bottle for storing toner;
toner flow rate control means for controlling and supplying a constant amount at a time of toner stored in said toner bottle when said toner is used;
supplied toner amount detecting means for detecting an amount of said toner supplied by said toner flow rate control means when said toner flow rate control means is actuated to supply said toner; and
remaining toner amount calculating means for calculating a remaining toner amount in said toner bottle by subtracting said supplied toner amount detected by said supplied toner amount detecting means from a total amount in said toner bottle.

6. An image forming apparatus according to claim 5,
wherein said toner flow rate control means is formed of an auger and
said supplied toner amount detecting means is formed of auger rotation number detecting means for detecting a rotation number of said auger and computing means for calculating said supplied toner amount by multiplying said rotation number of said auger detected by said auger rotation number detecting means by a conveyed toner amount for a turn of said auger.

7. An image forming apparatus according to claim 5, further comprising display means for displaying said remaining toner amount calculated by said remaining toner amount calculating means.

8. An image forming apparatus according to claim 5, further comprising display means for displaying that said remaining toner amount is small when said remaining toner amount calculated by said remaining toner amount calculating means is equal to or smaller than a set amount.

9. An image forming apparatus comprising:
a toner bottle for storing toner;
toner bottle rotating means for rotating said toner bottle;
toner bottle rotation number detecting means for detecting a rotation number of said toner bottle rotated by said toner bottle rotating means;
an auger rotated synchronously with said toner bottle to control and supply a constant amount at a time of toner stored in said toner bottle when said toner is used;
computing means for calculating a supplied toner amount by multiplying said rotation number of said auger determined according to said rotation number of said toner bottle detected by said toner bottle rotation number detecting means by a conveyed toner amount for a turn of said auger;
remaining toner amount calculating means for calculating a remaining toner amount in said toner bottle by subtracting said supplied toner amount calculated by said computing means from a total amount in said toner bottle; and
display means for displaying said remaining toner amount calculated by said remaining toner amount calculating means or for displaying that said remaining toner amount is small when said remaining toner amount is equal to or smaller than a set amount.

10. An image forming apparatus according to claim 9,
wherein said toner bottle rotating means and said auger are operated by the same driving means.

11. An image forming apparatus according to claim 9,
wherein said toner bottle is provided with a toner buffer and said auger is mounted in said toner buffer.
